(19) United States
(12) Patent Application Publication
(10) Pub. No.: US 2005/0010501 A1
(43) Pub. Date: Jan. 13, 2005

(54) Internet-based back office payroll service and method thereof

(76) Inventor: Lycurgus B. Ward JR., Marietta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/616,781

(22) Filed: Jul. 10, 2003

(51) Int. Cl. G06F 17/60

(52) U.S. Cl. 705/30

(57) ABSTRACT

An internet-based back office payroll service and method thereof that provides an accounting firm or other nonpayroll service provider with the ability to provide its clients with payroll processing services without the associated labor and management overhead by outsourcing such services, yet still retaining the appearance of a direct relationship between the accounting firm and its clients, thereby permitting the accounting firm to retain its “brand” image as the actual payroll processor, enhance its image as a full-service provider, and thus improve client retention.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to payroll services and associated methods, and more specifically to an Internet-based back office payroll service and method thereof. The present invention is particularly suitable for, although not strictly limited to, enabling a non-payroll service provider, such as an accountant, to offer and provide payroll services to customers through internet-supported software adapted to interact with back office payroll processors to yield processed payrolls to the customer through the non-payroll service provider, thereby masking the underlying payroll processor from the customer.

### BACKGROUND OF THE INVENTION

Many progressive accounting firms typically provide payroll processing services as a means for enhancing client services to improve client retention and overall profitability. However, client demands for such payroll processing services generally peak at regular intervals that typically last for less than a conventional workweek. As such, continuous or permanent maintenance of adequate staffing for such abridged periods of peak demand can often result in substantial overhead costs that may outweigh or detract from any financial benefit garnered from offering such payroll services.

Moreover, many small accounting firms are often forced to refer existing clients to outside companies specializing in payroll processing services, because such small firms are unable to absorb the overhead and relatively small profit margins associated with providing payroll processing services to a limited number of clients.

As would be expected, the inability of an accounting firm, or the like, to provide a “one-stop-shop,” that is, to be a general practice firm replete with a variety of services, including payroll processing services, can lead to a client's perception of the firm as inadequate or limited in performance when compared to a competing firm offering complete financial services, including payroll processing services. Even if a firm forms a cooperative relationship with an outside company specializing in payroll services, clients typically interact with and receive the processed payroll directly from the payroll service provider or company, and not from the associated firm, and may therefore still associate feelings of dissatisfaction or inadequacy therewith. As a result, many clients may prefer the services of a firm having an in-house payroll processing service, in addition to other desired services, for purposes and convenience of maintaining all required accounting services with one firm.

Therefore, it is readily apparent that there is a need for an internet-based back office payroll service and method thereof that provides an accounting firm or other nonpayroll service provider with the ability to provide its clients with payroll processing services without the associated labor and management overhead by outsourcing such services, yet still retaining the appearance of a direct relationship between the accounting firm and its clients, thereby permitting the accounting firm to retain its “brand” image as the actual payroll processor, enhance its image as a full-service provider, and thus improve client retention.

### BRIEF SUMMARY OF THE INVENTION

Briefly described, in a preferred embodiment, the present invention overcomes the above-mentioned disadvantages and meets the recognized need for such a system and method by providing an Internet-based back office payroll service, and method thereof that provides an accounting firm or other nonpayroll service provider with the ability to provide its clients with payroll processing services without the associated labor and management overhead by outsourcing such services, wherein the present invention utilizes a computer software program designed to run or operate unattended on an office computer, receiving incoming facsimile data transmissions and automatically forwarding the data to the back office service provider. The present inventive system and method is intended to act as a storefront, offering payroll services by the accountant, wherein payroll data is transmitted through the accountant's computer Internet or facsimile link to the back office payroll service provider for processing, and wherein the completed or processed payroll and associated information is subsequently transmitted through a server back to the accountant. After receiving the processed payroll, the accounting office can selectively print and/or report to the client the appropriate payroll information, representing at all times the accountant as the true provider of the payroll product and masking the back-office payroll processor from the client.

According to its major aspects and broadly stated, the, present invention in its preferred form is an Internet-based back office payroll service and method thereof that utilizes a computer program adapted to run or operate unattended and receive payroll information for outsourcing to a payroll processing company, wherein processed payroll information is returned to the software user for selective management and distribution of same.

More specifically, the present invention is an Internet-based back office payroll service and method thereof adapted to provide back office clerical payroll processing for any size accounting firm or other payroll service provider, wherein application of the present invention is designed to eliminate the overhead and labor constraints imposed on such firms, yet still increase client satisfaction and retention. Preferably, a computer software program is designed to operate unattended on an office computer (P.C.) and to receive payroll information preferably in the form of facsimile data transmissions or other Internet data transmissions, wherein such information is routed or forwarded, through a server to a back office payroll service provider or processor. Completed or processed payroll data is selectively, or automatically, retrieved by the software user (i.e., accounting firm, or the like) from the back office payroll service provider's server for selective printing, distribution and/or management of same by the user.

The user preferably installs the program on a personal computer and configures the software to receive the incoming faxes or Internet data transmissions from clients entered into the user database. When the software application is in the “listen mode”, the program is prepared to receive faxes or the like and electronically route or forward same to the server for subsequent electronic delivery to the selected (back office) payroll processor. When in the listen mode, a user may “minimize” the software application, allowing it to operate in the “background” unattended.

When the user is ready to deliver a completed or processed payroll product to a client, the user preferably restores the software application to the computer desktop (i.e., graphical interface) and downloads or retrieves the completed payroll files delivered to the user from the server. When operating the software application, the user may select from a variety of management tools or tabs, including, but not limited to, a “Checks” tab for viewing and/or printing check files, a “Reports” tab for viewing and/or printing payroll report files, or a “Data” tab for a list of data files for exporting or for importing same into the user's general ledger accounting program or package. After retrieving the desired payroll information from the application, or upon automated importation thereof, the user preferably prints out the payroll information and delivers the information to the client. As such, the client can have no contact with anyone other than the software user (i.e., accountant or other service provider), thereby permitting the user to retain its “brand” image as the actual payroll processor, enhance its image as a full-service provider, and thus improve client retention.

Accordingly, a feature and advantage of the present invention is its ability to reduce an accounting firm's overhead expense and overall cost of processing payroll, while at the same time improving client retention and perceived involvement in the payroll processing service.

Another feature and advantage of the present invention is its ability to retain the appearance of a direct relationship between an accounting firm and its clients, thereby permitting the accounting firm to retain its “brand” image as an actual payroll processor, enhance its image as a full-service provider, and thus improve client retention.

Another feature and advantage of the present invention is its incorporation of a computer software program adapted to operate unattended on an office computer to electronically receive payroll information for subsequent processing of same.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a general flow diagram of the method of an Internet-based back office payroll service according to a preferred embodiment of the present invention.

FIG. 2 is an illustration of a graphical tab dialogue box of the software application of an Internet-based back office payroll service according to a preferred embodiment of the present invention.

FIG. 3 is an illustration of a graphical tab dialogue box of the software application of an Internet-based back office payroll service according to a preferred embodiment of the present invention.

FIG. 4 is an illustration of a graphical tab dialogue box of the software application of an Internet-based back office payroll service according to a preferred embodiment of the present invention.

FIGS. 4A-4F are illustrations of printable reports provided by the software application of an Internet-based back office payroll service according to a preferred embodiment of the present invention.

FIG. 5 is an illustration of a graphical tab dialogue box of the software application of an Internet-based back office payroll service according to a preferred embodiment of the present invention.

FIG. 6 is an illustration of a graphical tab dialogue box of the software application of an Internet-based back office payroll service according to a preferred embodiment of the present invention.

FIG. 7 is an illustration of a graphical tab dialogue box of the software application of an Internet-based back office payroll service according to a preferred embodiment of the present invention.

FIG. 8 is a general flow chart of the software program flow of an Internet-based back office payroll service according to a preferred embodiment of the present invention.

### DETAILED DESCRIPTION OF THE PREFERRED AND ALTERNATIVE EMBODIMENTS

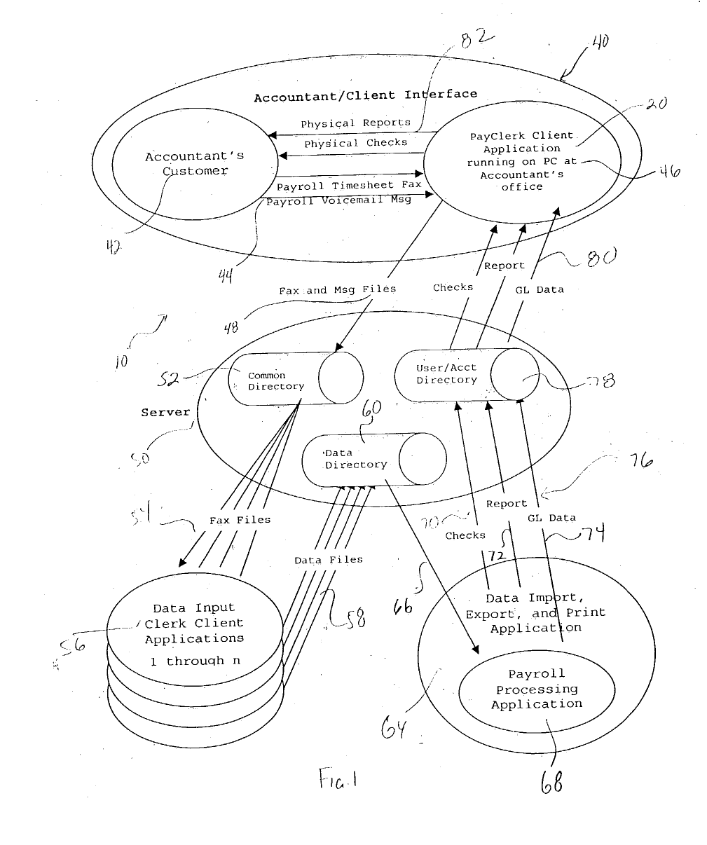

In describing the preferred and alternate embodiments of the present invention, as illustrated in FIGS. 1-8, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment is an Internet-based back office payroll service 10 having software application 20 and associated method of implementation 40. Preferably, software application 20 (i.e., preferably marketed under the trademark PAYCLERK) is installed and operated on a user's computer via conventional methods of installation as known within the art. Thereafter, the installed software application 20 is preferably programmed or configured to receive and/or listen for incoming facsimile data transmissions and/or digital voice messaging data transmissions to facilitate the present payroll processing method 40, as more fully described below.

Preferably, method 40 entails payroll information transmission 44 by customer 42 to accountant's PC 46, or office computer, via facsimile data transmissions and/or digital voice messaging data transmissions. It is recognized that other data transmission methods could be utilized such as, for exemplary purposes only, electronic mail, or any other appropriate means of data conveyance. Preferably, the received payroll information is then forwarded 48 as individual files having unique and/or otherwise identifying codes, preferably barcodes, to common directory 52 of payroll server 50, wherein the payroll information is preferably identified via Optical Character Recognition (OCR) and routed to a payroll operator by utilizing Transmission Control Protocol/Internet Protocol (TCP/IP), via the Internet or other global networking system so as to shield the customer from knowledge of same.

Preferably, payroll information retrieval 54 from common directory 52, by payroll operator, enables payroll data recognition and verification, wherein said retrieval 54 could also be enabled via the Internet or other global networking system, or any other appropriate data transmission method. Upon payroll data retrieval 54, preferably third-party application 56 is utilized to recognize, individually identify via bar code or other coding means, and convert the faxed and/or digital voice message payroll data into a useable data format for payroll processing services, preferably via OCR, Intelligent Character Recognition (ICR), or any other appropriate data translation means, wherein the converted payroll data files could be distributed among several payroll operators/processors for purposes of processing same.

Following recognition and verification of the payroll data, payroll data exportation 58 is preferably performed by the payroll operator, wherein the data files are preferably retransmitted to data directory 60 of server 50. Preferably, data file retrieval 66 is performed by back office payroll processor 64, wherein the data files from data directory 60 are imported, preferably automatically, into payroll processing application 68 for subsequent payroll processing, whereby the user avoids the necessity of “key stroke” downloads, if desired. Preferably, individual company databases are maintained for each individual company, wherein preferably uniquely coded client data is input into back-office payroll processor 64 prior to initiation and use of the system.

Preferably, after the data files, or payroll data, have been processed via payroll processing application 68, payroll checks 70, payroll reports 72, transactions, journal entries, general ledger reports 74 and/or any other desirable data or information are preferably exported as read-only soft copies and transmitted 76 to individual user/account spaces or directories 78 of server 50, preferably multiple servers.

Thereafter, processed payroll data retrieval 80 is preferably performed by accountant 46 following the automated importing of same onto office computer of accountant 46 to enable the printing of checks 70, reports 72, or other useable information, including general ledger data or reports 74. Upon request for processed payroll information, checks, reports, or the like, by customer 42, accountant 46 preferably transmits information 82 such as physical reports, issued checks, written confirmation of electronic processing and/or any other relevant payroll related information to customer 42, reflecting accountant 46 as the provider of the payroll product, in lieu of the back office payroll processor 64, thereby masking payroll processor 64 from customer 42, wherein accountant 46 remains the true liason and direct provider.

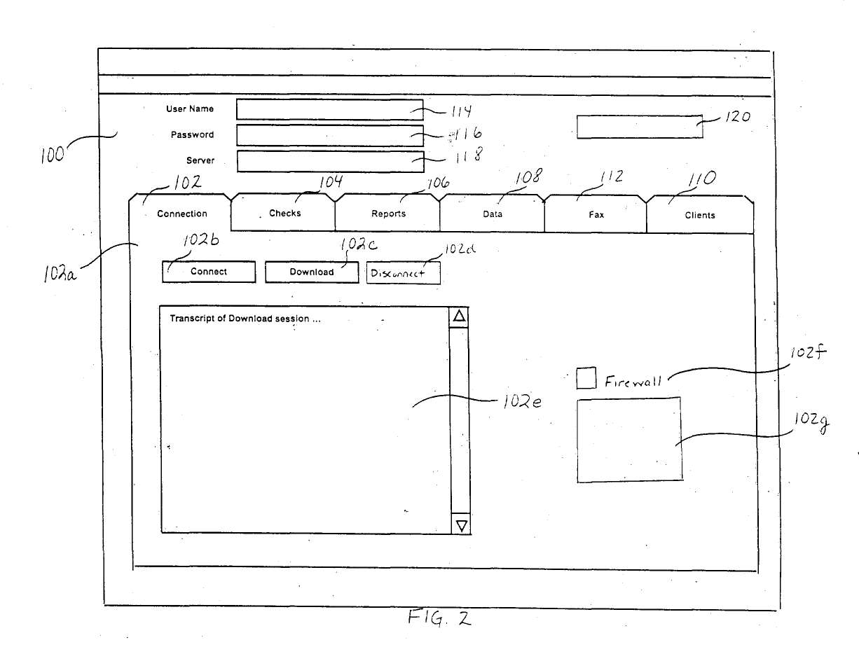

Referring now to FIGS. 2, 3, 4, 5, 6 and 7, illustrated therein are graphical user interfaces of the preferred software application 20 utilized by accountant 46 is the above-described method 40, wherein each figure preferably depicts an SSTab object; or graphical tab dialogue box, 100 having a plurality of user-selectable tabs. Specifically, a user of software application 20 is preferably able to select from connection tab 102, checks tab 104, reports tab 106, data tab 108, clients tab 110, and fax tab 112, the provisions and functions of which are more fully described below. One skilled in the art would readily recognize that, while the aforementioned arrangement is preferred, any variety or arrangement of tabs, or selectable interfaces, could be utilized, wherein different combinations of features could be represented thereby.

Each SSTab object 100 preferably includes username textbox 114 for receiving username data, password textbox 116 for receiving the applicable security code, and assigned contact domain or server textbox 118 for receiving the appropriate contact or server address. Preferably, label 120 is utilized to display messages informing the user of background facsimile activity or related information. A prospective user preferably evaluates the program and transmission of information, facsimile or the like, by leaving the default text in username textbox 114, password textbox 116, and server textbox 118, wherein subsequent entry of a selected username, password and applicable server within respective textboxes 114, 116 and 118, respectively, preferably enables the user or accountant 46 to retrieve the complete or processed payroll work product for review and/or delivery to customer 42.

Referring now more specifically to FIG. 2, selection of preferred connection tab 102 preferably yields associated connection tab sheet 102a, wherein sheet 102a preferably includes connect command button 102b, download command button 102c, disconnect command button 102d, and list box 102e, wherein listbox 102e is for informing the user of the download status. Connection tab sheet 102a further provides the user with option buttons 102f and text boxes 102g to enable firewall negotiation. Preferably, clicking connect command button 102b results in the program or application 20 connecting to the user's account 78 at server 50 or other common website regulated and governed by the proprietors of the present software application 20 and associated method 40 (i.e., preferably operating under the trademark PAYCLERK). After successfully accessing account information 78, a user is preferably capable of retrieving a control file for determining which payroll data files have not yet been downloaded, and downloading the applicable data files, wherein such data files are preferably listed in tables found on the tab sheets associated with checks tab 104, reports tab 106 and data tab 108, as more fully described below.

Preferably, after selecting, or “clicking” on, connect command button 102b, a message is conveyed in list box 102e informing the user when the connection to server 50 has been made, and when the current work product may be downloaded. Preferably, clicking of download command button 102c results in application 20 determining whether a current “control file” is located on server 50, wherein determination of same results in the downloading of the encrypted and/or password protected control file, in addition to the checks and report files for the current period, as identified in the control file.

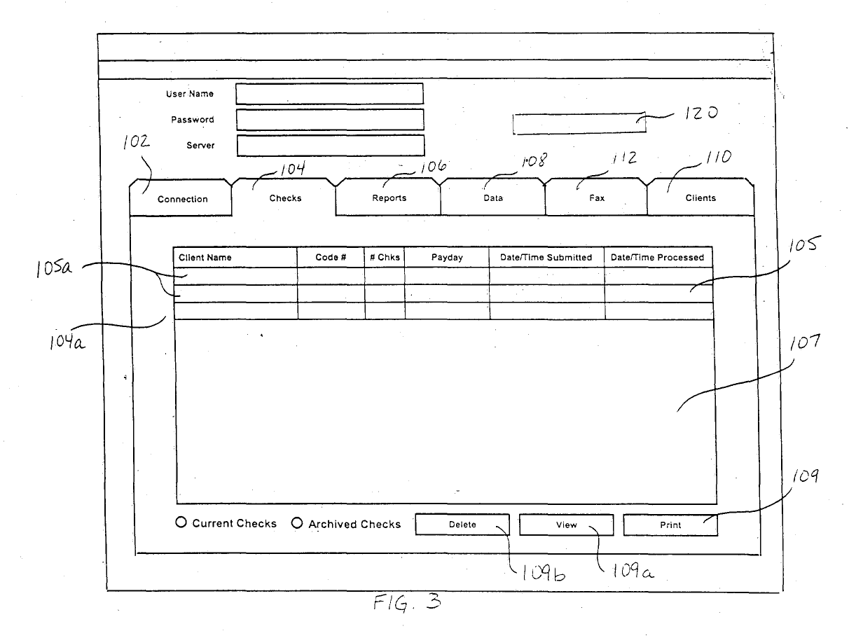

Referring now more specifically to FIGS. 3-5, selection of checks tab 104, reports tab 106 and data tab 108 preferably yields associated checks tab sheet 104a, reports tab sheet 106a, and data tab sheet 108a, respectively, wherein checks tab sheet 104a, reports tab sheet 106a and data tab sheet 108a are preferably similar in appearance and function. Preferably, each of checks tab sheet 104a, reports tab sheet 106a and data tab sheet 108a preferably include data grid 105, wherein data grid 105 of checks tab sheet 104a, reports tab sheet 106a and data tab sheet 108a preferably displays client payroll files and associated information for unprinted, current and/or archived payrolls, as more fully described below.

Specifically, data grid 105 of checks tab sheet 104a, reports tab sheet 106a, and data tab sheet 108a is preferably populated with a list of files representing checks or reports, either that have not yet been printed or archived, per selection by the user. To print, delete or view checks, reports or data from checks tab sheet 104a, reports tab sheet 106a, or data tab sheet 108a, respectively, the user preferably selects a record (i.e., a row) 105a from data grid 105, preferably highlighting same. Selection of view button 109a enables the user to view the details of the highlighted record 105a. Selection of delete button 109b enables the user to remove the highlighted record 105a from the list. Selection of print command button 109 preferably results in the appearance of a confirmation message within message box 107 prior to the printing of the checks or reports of record 105a. To proceed with the print job, the user preferably confirms the record 105a print selection by clicking on message box 107, wherein the program then directs the specified print files to the selected, configured or networked printer.

Preferably, following selection and printing of the desired record 105a, the selected record 105a in the checks tab sheet 104a, reports tab sheet 106a, or data tab sheet 108a is updated in the control file, removed from the list of files available for printing from data grid 105, and archived. Preferably, checks, reports or other data may be printed individually by selecting the desired checks, reports, or data on the tab sheet.

Preferably, data grid 105 of data tab sheet 108a is populated with a list of current data files. To avoid old data files from being overwritten, a user should preferably import current data files into the user's general ledger accounting program prior to downloading a new data file.

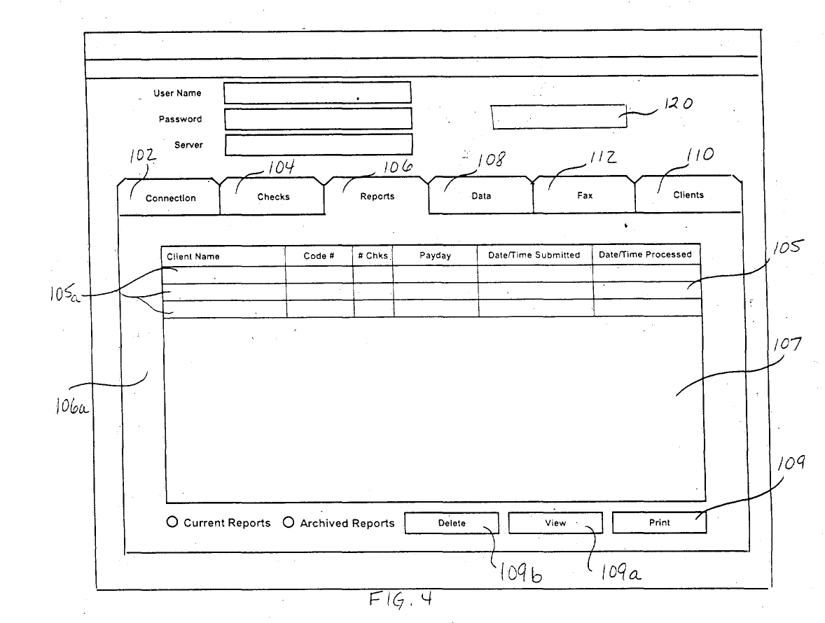

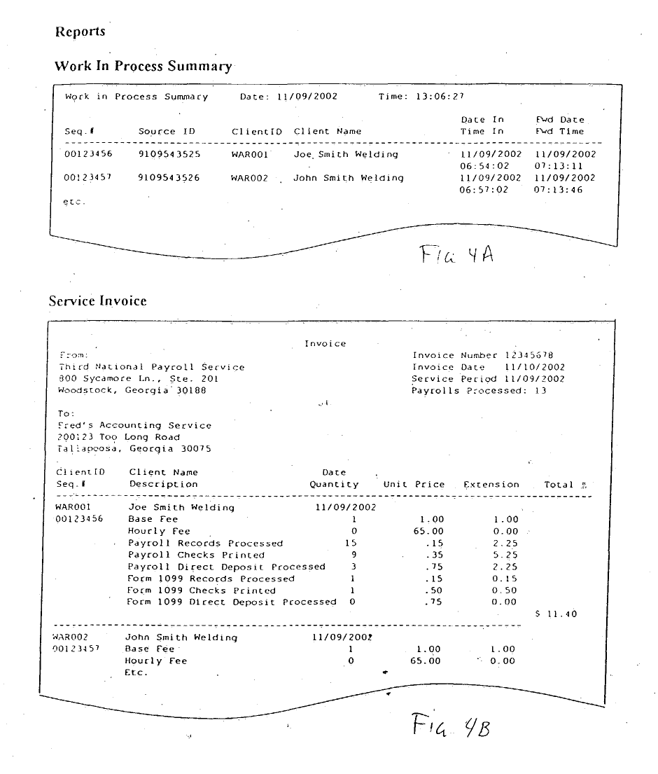

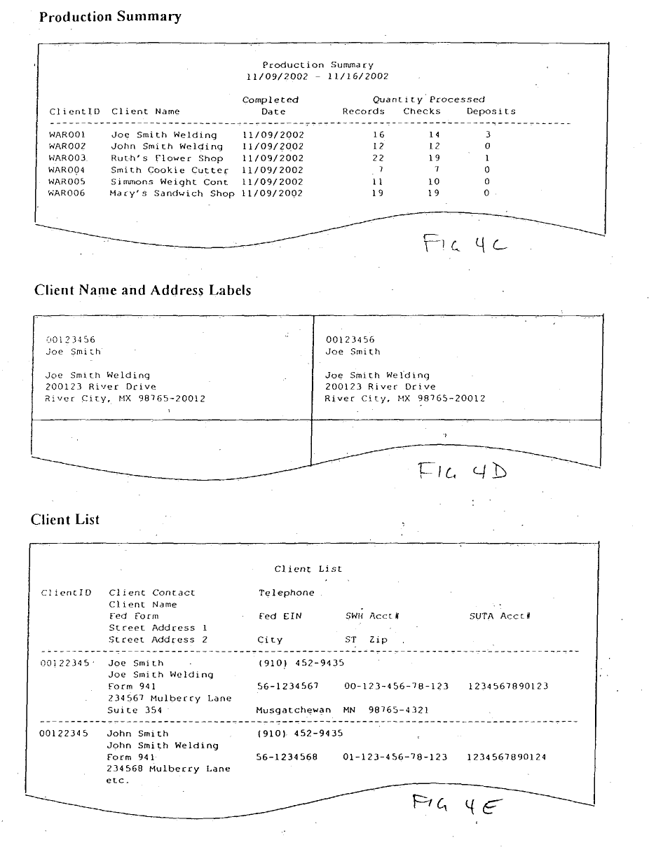

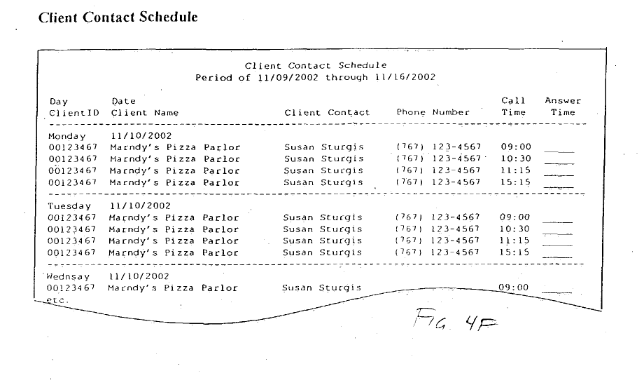

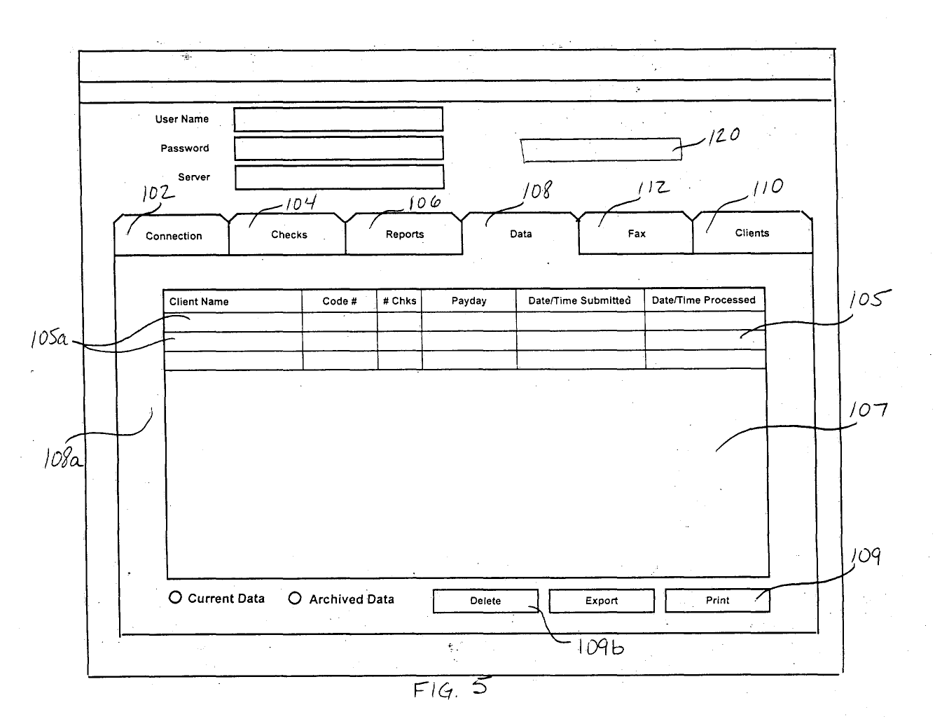

Referring now more specifically to FIGS. 4A-4F, illustrated therein are preferred format printable reports provided by software application 20. Specifically, FIG. 4A depicts a work in process summary; FIG. 4B depicts a service invoice; FIG. 4C depicts a production summary, FIG. 4D depicts client name and address labels; FIG. 4E depicts a client list; and, FIG. 4F depicts a client contact schedule. Although FIGS. 4A-4F illustrate the preferred configuration or format for printable reports, it should be recognized that any suitable configuration and/or arrangement could be utilized without departing from the appreciative scope of the present invention, as such alternate configurations and/or arrangements are in full contemplation of the inventor in describing the present invention herein.

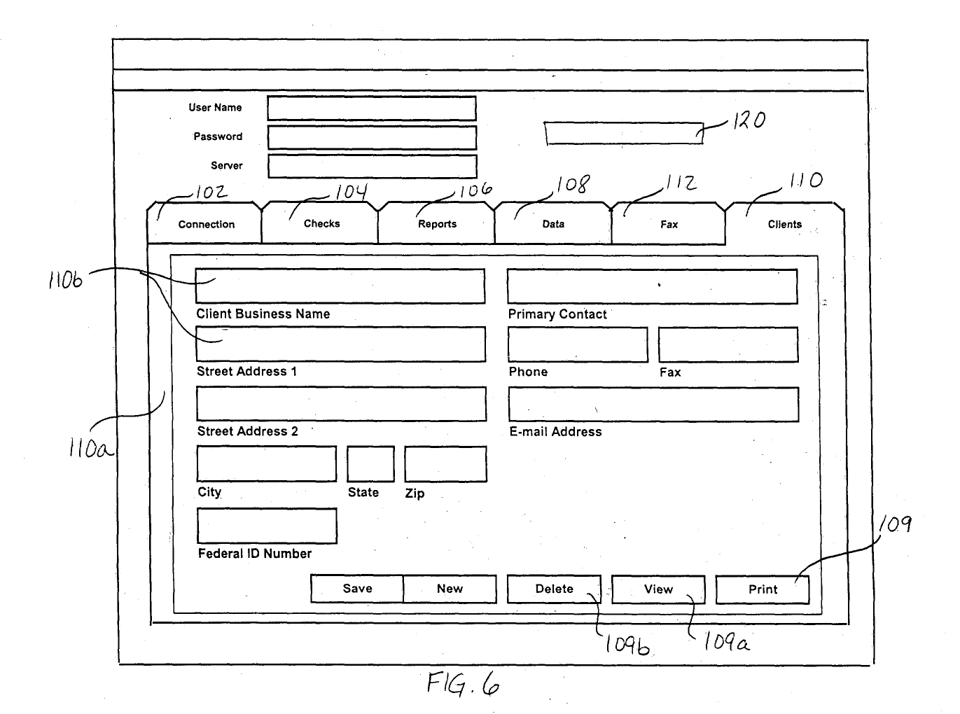

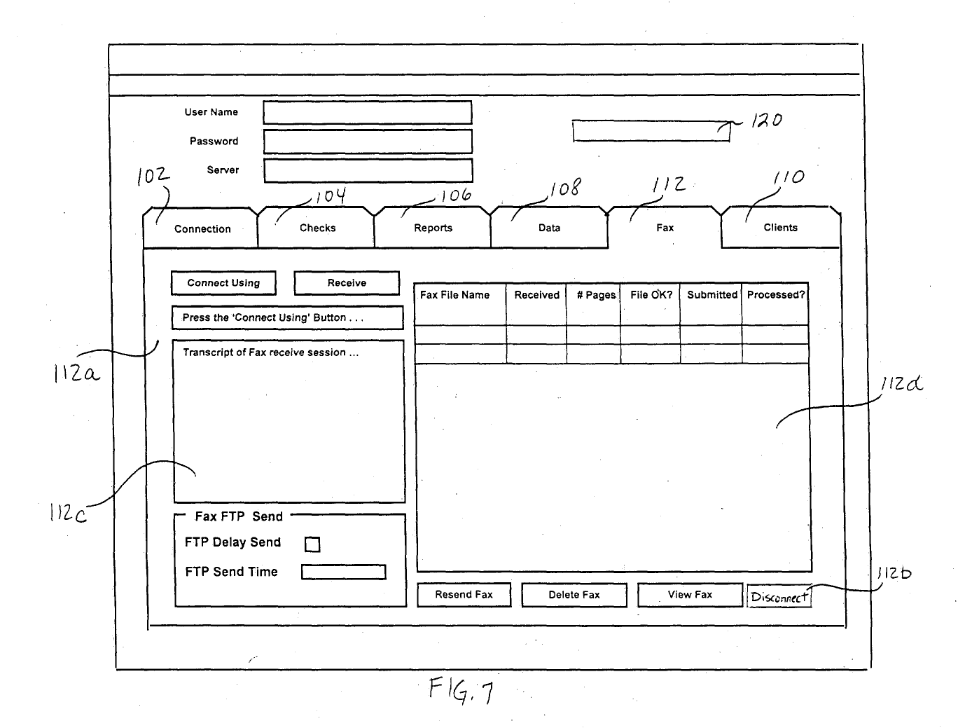

Referring now more specifically to FIG. 6, selection of client tab 110 preferably yields associated client tab sheet 110a, wherein sheet 110a preferably includes a series of combo boxes 110b, wherein boxes 110b preferably permit a user to enter and/or modify a database record for each client. Combo boxes 110b preferably enable storage, retrieval and sorting of client contact information and also preferably include individual bar code or other unique identified information. One skilled in the art would readily recognize that any desirable information could alternately be included as a supplement to or in place of the preferred client data as shown in FIG. 6.

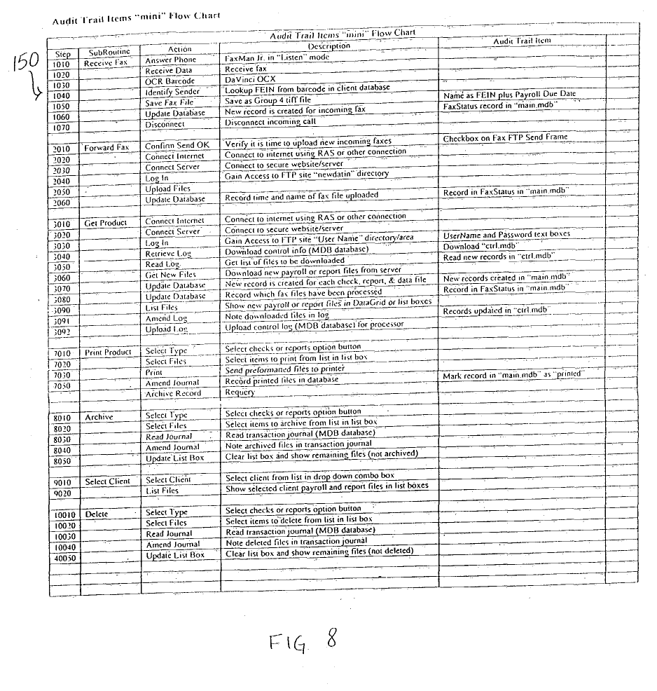

Referring now more specifically to FIG. 7, selection of fax tab 112 preferably yields associated fax tab sheet 112a, wherein sheet 112a preferably enables a user to select the connection device, or Com Port/Modem, to enable the listen mode for automatically receiving incoming facsimile data transmissions and/or digital voice messaging data transmissions relating to payroll information. As previously noted, although facsimile and/or digital voice message of data is preferred, said data could also be transmitted via email or other appropriate form of global communication transfer. Preferably, a disconnect command button 112b permits the user to selectively disable the listening mode of the modem.

Preferably, text box 112c displays information related to the progress of receipt of an incoming facsimile or digital voice message, wherein the status of modem activity is preferably displayed on the background form so as to permit viewing of same while the user is performing other relevant actions.

Grid list box 112d preferably displays customer names, date of receipt of the facsimile or digital voice message transmission, and the time of receipt of any facsimile or digital voice message transmission that has not yet had processed payroll data returned, thereby disclosing to the user any overdue payroll. Alternately, the user could view the facsimile (or otherwise transmitted) data via a web browser, such as, for exemplary purposes only, WINDOWS EXPLORER, wherein the user could locate the data transmissions in a received data, or faxes, directory (not shown), and view the transmissions by making an appropriate selection in the browser window.

Referring now more specifically to FIG. 8, illustrated therein is preferred general program flow 150 of software application 20. Although FIG. 8 illustrates the preferred program flow of software application 20, it should be recognized that any suitable program flow could be utilized to effectuate software application 20 without departing from the appreciative scope of the present invention, as such alternate program flows are in full contemplation of the inventor in describing the present invention herein. As such, any process descriptions or blocks in program flow 150 should be understood as representing modules, segments, or portions of code which include one or more executable instructions for implementing specific logical functions or steps in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

It is contemplated in an alternate embodiment that each tab sheet could incorporate a means for deleting files, wherein the user would be required to confirm deletion of the selected files.

It is contemplated in an alternate embodiment that fax tab sheet 112 could incorporate means for providing a user the choice of when to send fax files, or the like, wherein such means could include a drop down combination box and/or option buttons that permit the user to select between an “Auto-Send” or “Manual-Send” fax function.

It is contemplated in an alternate embodiment that software application 20 could provide means for re-sending or re-submitting facsimile data transmissions and/or digital voice message transmissions.

It is contemplated in an alternate embodiment that software application 20 could provide the user with the ability to receive exported payroll data.

It is contemplated in an alternate embodiment that software application 20 could be utilized by any type of professional, in addition to or in lieu of an accountant, wherein said professional service provider could provide payroll services to customers.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A system for providing payroll services via a masked third-party processor, comprising the steps of:
a) enabling communication of customer payroll data from the customer to the payroll provider via a first means of data transmission;
b) transmitting the customer payroll data from the payroll provider to a third-party payroll processor via a second means of data transmission;
c) processing the customer payroll data by the third-party processor;
d) transmitting the processed payroll information from the third-party processor to the payroll provider; and
e) enabling communication of the processed payroll information from the payroll provider to the customer via a third means of data transmission,
wherein the third-party processor and the customer communicate with and are associated through the payroll provider.

2. The system of claim 1, wherein first means of data transmission is a facsimile data transmission.

3. The system of claim 1, wherein said first means of data transmission is a digital voice data transmission.

4. The system of claim 1, wherein said first means of data transmission is electronic file transmission via a global networking system.

5. The system of claim 1, wherein said second means of data transmission is electronic file transmission via a global networking system.

6. The system of claim 1, wherein said third means of data transmission is facsimile data transmission.

7. The system of claim 1, wherein said customer payroll data is transferred to a common server and wherein the third-party processor retrieves said customer payroll data from said server.

8. The system of claim 7, wherein said customer payroll data retrieved from a common directory of said server is recognized and verified via third-party applications.

9. The system of claim 8, wherein said recognized and verified customer payroll data is retransmitted to a data directory of said server.

10. The system of claim 9, wherein the third party payroll processor accesses said data directory and utilizes said data to yield said processed payroll information.

11. The system of claim 10, wherein said processed payroll information is transmitted to an account directory of said server.

12. The system of claim 11, wherein said account directory of said server comprises checks file, reports file and transactions file.

13. The system of claim 11, wherein said account directory is accessed by said payroll provider for retrieval, review and distribution of said processed payroll information to the payroll customer.

14. The system of claim 12, wherein said checks file, said reports file and said transactions file enable generation of printed reports.

15. The system of claim 1, wherein said first, second and third means of data transmission are global networking system transmissions sent utilizing Transmission Control Protocol/Internet Protocol to shield the customer from the third-party payroll processor.

16. The system of claim 1, wherein said system if implemented via a software application installed on a computer of said payroll provider.

17. A method of providing payroll processing services, said method comprising the steps of:
a. installing a software application on a computer of a non-payroll processing entity, said software application configurable to receive payroll processing request transmissions from a customer;
b. forwarding said payroll processing request transmissions to a common server accessible by a payroll processing entity via a global networking system;
c. processing said payroll processing request transmissions into useable payroll data to yield a processed payroll file;
d. transmitting said processed payroll file to said server; and
e. permitting said non-payroll processing provider to retrieve said processed payroll file and selectively distribute said processed payroll file to the customer from whom said payroll processing request transmissions originated.

18. A software application for facilitating the provision of payroll processing services, said software application comprising:
means for receiving payroll processing request transmissions from a customer;
means for transmitting said payroll processing request transmissions from a non-payroll processing entity to a payroll processing entity to yield a processed payroll file;
means for retrieving said processed payroll file;
means for managing said processed payroll file; and
means for distributing said processed payroll file to the customer.

19. The software application of claim 18, wherein said receiving means comprises a modem configurable to operate in a listen mode and receive said payroll processing request transmissions in the form of facsimile data transmissions.

20. The software application of claim 18, wherein said transmitting means comprises a command button to access a main server through the global networking system for transmission of said payroll processing request transmissions to said payroll processing entity.

21. The software application of claim 18, wherein said retrieving means comprises a download function configured to download said processed payroll file from said server.

22. The software application of claim 18, wherein said managing means comprises a checks file data grid for managing check files retrieved from said processed payroll file.

23. The software application of claim 18, wherein said managing means comprises a reports file data grid for managing report files retrieved from said processed payroll file.

24. The software application of claim 18, wherein said distributing means comprises a checks select and print function for selectively printing at least a portion of said processed payroll file.

25. The software application of claim 18, wherein said distributing means comprises a reports select and print function for selectively printing at least a portion of said physical copies of said processed payroll file.
